(19) United States
(12) Patent Application Publication
(10) Pub. No.: US 2015/0092025 A1
(43) Pub. Date: Apr. 2, 2015

(54) STEREO DISPLAY DEVICE

(71) Applicant: Au Optronics Corporation, Hsinchu (TW)

(72) Inventors: Ching-Tsun Chang, Tainan City (TW); Ren-Wei Liao, Hsinchu County (TW); Hsuan-I Wu, Kinmen County (TW)

(73) Assignee: Au Optronics Corporation, Hsinchu (TW)

(21) Appl. No.: 14/178,257

(22) Filed: Feb. 11, 2014

(30) Foreign Application Priority Data
Oct. 1, 2013 (TW) 102135524

(51) Int. Cl. H04N 13/04

(52) U.S. Cl. CPC H04N 13/0409
USPC 348/54

(57) ABSTRACT

A stereo display device includes a display panel and a barrier panel. The display panel includes a plurality of sub-pixel units arranged in an array along an X-direction and a Y-direction. At least three sub-pixel units form a pixel unit. The barrier panel is located at one side of the display panel and includes a plurality of first electrodes, a plurality of second electrodes, and an optically anisotropic medium. An included angle between an extension direction of the first electrodes and the Y-direction is +θ1, and θ1≠0 degree. An included angle between an extension direction of the second electrodes and the Y-direction is −θ2, and θ2≠0 degree. The optically anisotropic medium is located between the first electrodes and the second electrodes.

### CROSS-REFERENCE TO RELATED APPLICATION

This application claims the priority benefit of Taiwan application serial no. 102135524, filed on Oct. 1, 2013. The entirety of the above-mentioned patent application is hereby incorporated by reference herein and made a part of this specification.

### BACKGROUND OF THE INVENTION

1. Field of the Invention

The invention relates to a display device, and more particularly, to a stereo display device.

2. Description of Related Art

In recent years, continuous advancement of display technologies results in increasing demands on display quality of display devices, such as image resolution, color saturation, and so on. To satisfy users' requirements for viewing true images, display devices that are not only characterized by high image resolution and satisfactory color saturation but also capable of displaying stereo images have been developed.

Among the existing stereo display technologies, the spatial-multiplexed technology has flourished and matured. According to the spatial-multiplexed technology, in order to create stereo effects, different spatial viewing zones may be generated by means of parallax barrier or lenticular lenses, such that right and left eyes of a user may respectively receive different image information. The manufacturing technique of applying the parallax barrier is more mature than the manufacturing technique of employing the lenses and thus has been extensively used.

In the conventional stereo display device formed by means of the parallax barrier, the unfavorable alignment precision of assembling machines may lead to rotation errors and motion differences when a display panel and a barrier panel are aligned and adhered to each other. Hence, how to resolve the issue of alignment errors and accordingly reduce light leakage, color shift, and noise for improving the display quality of the stereo display device has drawn attention from the industry.

### SUMMARY OF THE INVENTION

The invention is directed to a stereo display device capable of reducing rotation errors and increasing tolerance of alignment errors without sacrificing the display quality.

In an embodiment of the invention, a stereo display device that includes a display panel and a barrier panel is provided. The display panel includes a plurality of sub-pixel units arranged in an array along an X-direction and a Y-direction and at least three sub-pixel units form a pixel unit. The barrier panel is located at one side of the display panel and includes a plurality of first electrodes, a plurality of second electrodes, and an optically anisotropic medium. An included angle between an extension direction of the first electrodes and the Y-direction is +θ1, and θ1≠0 degree. An included angle between an extension direction of the second electrodes and the Y-direction is −θ2, and θ2≠0 degree. The optically anisotropic medium is located between the first electrodes and the second electrodes.

In an embodiment of the invention, another stereo display device that includes a display panel and a barrier panel is provided. The display panel has an edge and includes a plurality of sub-pixel units arranged in an array along an X-direction and a Y-direction and at least three sub-pixel units form a pixel unit. The barrier panel is located at one side of the display panel and has an edge. Here, an included angle between the edge of the display panel and the edge of the barrier panel has a rotation threshold of alignment error, and the rotation threshold of alignment error is 2θ A resolution of the display panel is A×C, A<C, and 2θ satisfies:

$$2 θ = {tan}^{- 1} ( \frac{2 D}{A \times P} ) .$$

Here, P represents a width of one pixel unit, and D represents an alignment error threshold between the display panel and the barrier panel.

In an embodiment of the invention, yet another stereo display device that includes a display panel and a barrier panel is provided. The display panel is shaped as a rectangle and has a first side. Besides, the display panel includes a plurality of sub-pixel units arranged in an array along an X-direction and a Y-direction. The barrier panel is located at one side of the display panel. Besides, the barrier panel is shaped as a rectangle and has a second side. An acute angle between the first side and the second side ranges from 0.01 degree to 0.1 degree. The barrier panel includes a plurality of first electrodes extending along the Y-direction.

In view of the above, electrodes rotating in different directions are respectively arranged on two substrates of the barrier panel; after the display panel and the barrier panel are adhered to each other, the electrodes deviated from the Y-direction (i.e., the central line) to the less extent may serve as the barrier electrodes, and the electrodes deviated from the Y-direction to the greater extent may serve as the common electrodes (Com). Thereby, the rotation errors may be reduced, and the tolerance of the alignment errors may be doubled, so as to comply with the manufacturing requirements. Moreover, the stereo display device described herein is applicable to products with the large pixel per inch (PPI) or the small single barrier pitch (SBP).

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic cross-sectional view illustrating a stereo display device according to an embodiment of the invention.

FIG. 2 is a schematic top view illustrating the display panel depicted in FIG. 1.

FIG. 3 is a schematic top view illustrating a display panel according to another embodiment of the invention.

FIG. 4 is a schematic cross-sectional view illustrating the barrier panel depicted in FIG. 1.

FIG. 5 is a schematic top view illustrating the first electrode layer depicted in FIG. 1.

FIG. 6 is a schematic top view illustrating the second electrode layer depicted in FIG. 1.

FIG. 7 and FIG. 8 are schematic top views illustrating an assembled stereo display device according to an embodiment of the invention.

FIG. 9 is a schematic top view illustrating an assembled stereo display device according to another embodiment of the invention.

FIG. 10 and FIG. 11 are schematic cross-sectional views illustrating a barrier panel according to other embodiments of the invention.

### DETAILED DESCRIPTION OF DISCLOSED EMBODIMENTS

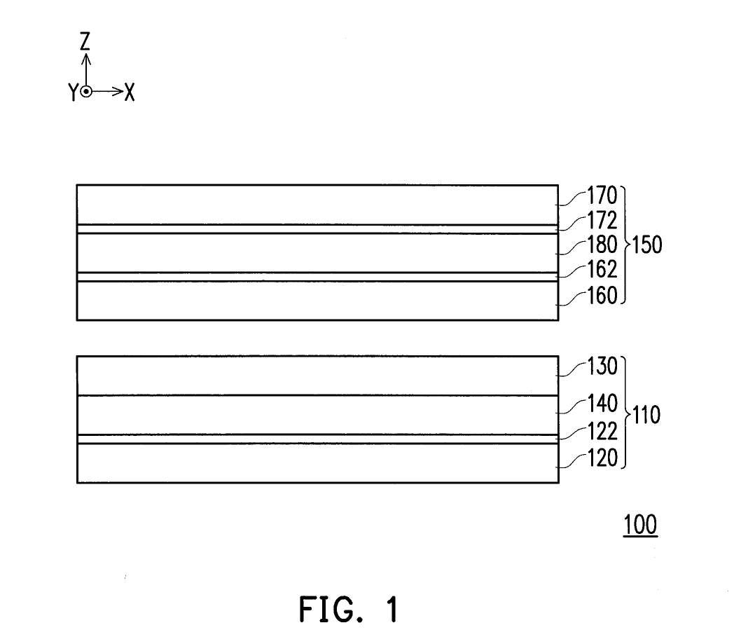

FIG. 1 is a schematic cross-sectional view illustrating a stereo display device according to an embodiment of the invention. The stereo display device 100 is capable of supporting a portrait display mode and/or a landscape display mode, for instance. Alternatively, the stereo display device 100 may be a switchable planar/stereo (2D/3D) display device or any other appropriate stereo display device, for instance.

With reference to FIG. 1, the stereo display device 100 includes a display panel 110 and a barrier panel 150 that is located at one side of the display panel 110. In the present embodiment, the display surface (not shown) of the display panel 110 faces the barrier panel 150, i.e., the barrier panel 150 is located above the display panel 110, for instance.

Here, the display panel 110 includes a pair of substrates 120 and 130, a pixel array 122 located on the substrate 120, and a display medium 140 located between the pair of substrates 120 and 130. Besides, the display panel 110 may be any component capable of displaying images, such as a liquid crystal display (LCD) panel, and organic light-emitting diode (OLED) display panel, an electrophoretic display panel, a plasma display panel, or any other display panel.

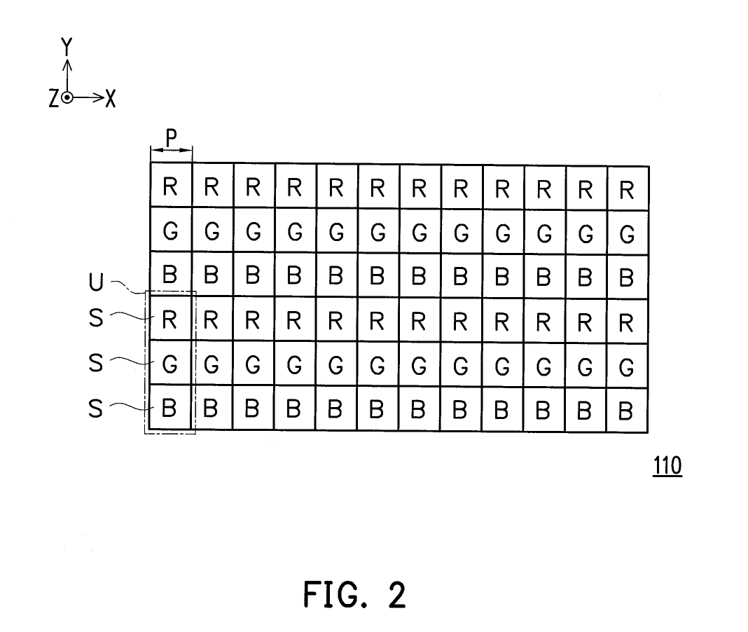

FIG. 2 is a schematic top view illustrating the display panel 110. With reference to FIG. 1 and FIG. 2, the display panel 110 has a plurality of pixel units U, each of the pixel units U includes a plurality of sub-pixel units S, and each of the pixel units U has a width P. The sub-pixel units S include red sub-pixel units R, green sub-pixel units G, and blue sub-pixel units B. The sub-pixel units S are arranged along an X-direction and a Y-direction, so as to constitute the pixel array 122. Hence, the pixel array 122 has plural columns in the Y-direction and plural rows in the X-direction. In general, each of the sub-pixel units S includes a data line, a scan line, an active device, a pixel electrode, and so forth in the pixel array 122. The sub-pixel units S may further include color filter patterns located in the pixel array 122 or on the substrate 130. Since the components of the sub-pixel units S are known to people having ordinary skill in the pertinent art, no other detailed explanation is further provided hereinafter.

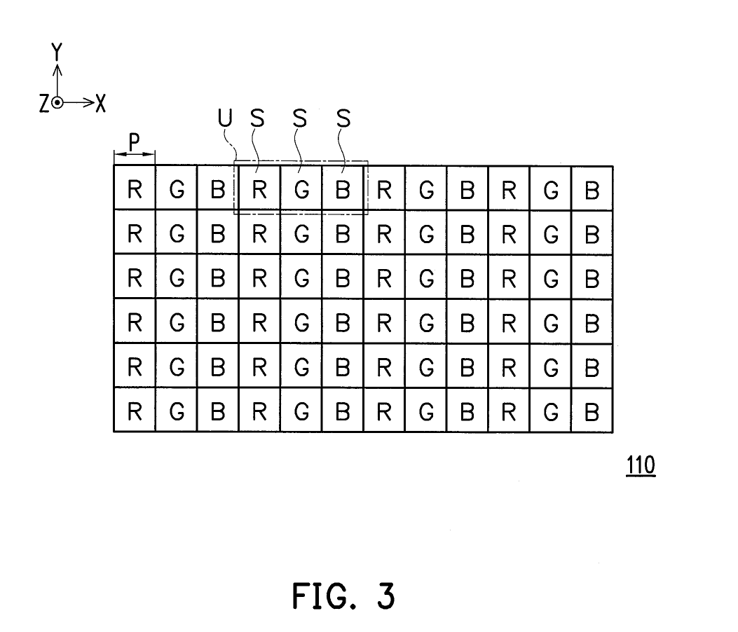

According to the present embodiment, a color of each column of the sub-pixel units S is repeated in a red-green-blue order, and a color of each row of the sub-pixel units S is identical. For instance, in the display panel 110 shown in FIG. 2, the sub-pixel units S in the first row are the red sub-pixel units R, the sub-pixel units S in the second row are the green sub-pixel units G, and the sub-pixel units S in the third row are the blue sub-pixel units B. However, the invention is not limited thereto, and the sub-pixel units S of the display panel 110 in other embodiments may be arranged in a manner as shown in FIG. 3. Specifically, in FIG. 3, a color of each row of the sub-pixel units S is repeated in a red-green-blue order, i.e., the red sub-pixel units R, the green sub-pixel units G, and the blue sub-pixel units B, and a color of each column of the sub-pixel units S is identical. Similarly, each of the pixel units U has a width P.

If the display panel 110 is an LCD panel, the display medium 140 is liquid crystal molecules, for instance. In other exemplary embodiments, if the display panel 110 is an OLED display, the display medium 140 is an organic light-emitting layer, for instance; if the display panel 110 is an electrophoretic display panel, the display medium 140 is an electrophoretic display medium, for instance; if the display panel 110 is a plasma display panel, the display medium 140 is a plasma display medium, for instance. Besides, in the display panel 110, if a non-self-illuminating material (e.g., a liquid crystal material) is applied as the display medium 140, the stereo display device 100 may selectively include a light source module for providing the light source required for displaying images.

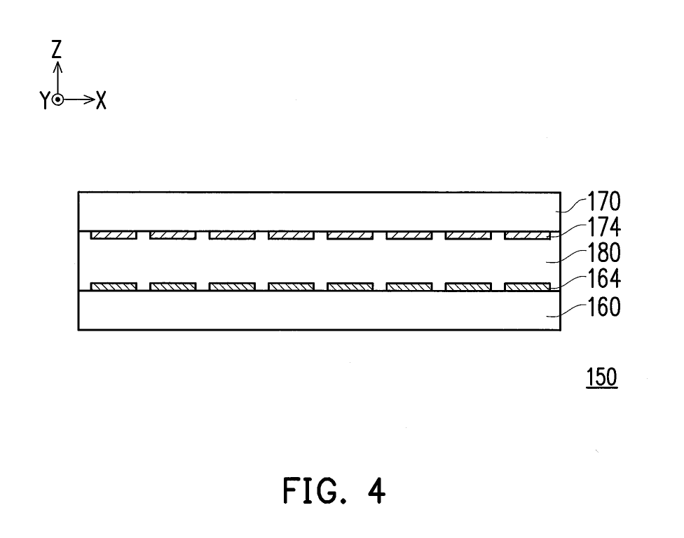

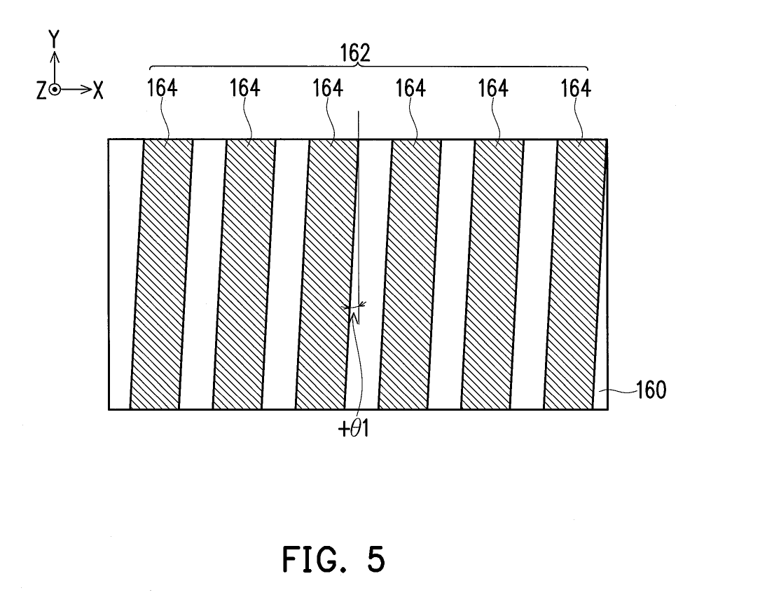

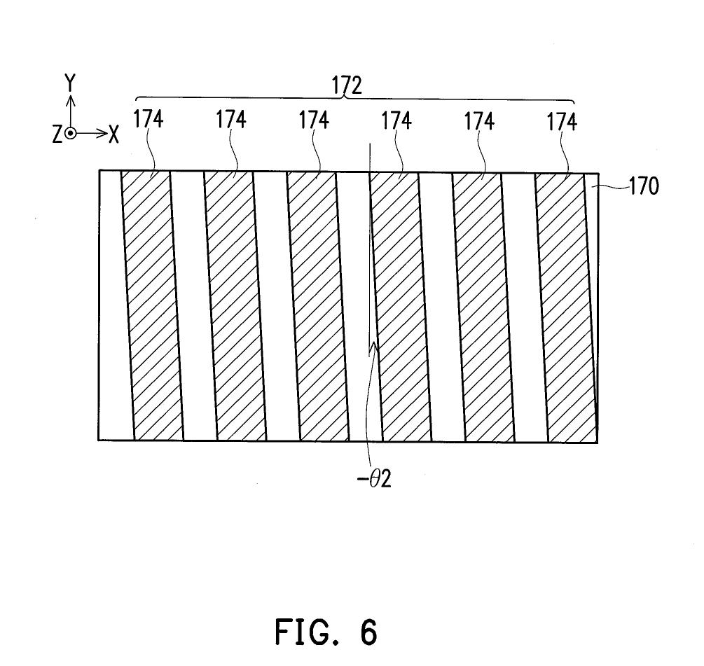

FIG. 4 is a schematic cross-sectional view illustrating the barrier panel 150. FIG. 5 and FIG. 6 are schematic top views respectively illustrating the first electrode layer 162 and the second electrode layer 172.

With reference to FIG. 1, FIG. 4, FIG. 5, and FIG. 6, the barrier panel 150 includes a first substrate 160, a first electrode layer 162, a second substrate 170, a second electrode layer 172, and an optically anisotropic medium 180.

The first substrate 160 and the second substrate 170 are opposite to each other and may be made of glass, quartz, organic polymer, or any other appropriate materials.

The optically anisotropic medium 180 is located between the first substrate 160 and the second substrate 170. Here, the optically anisotropic medium 180 is characterized by birefringence, e.g., liquid crystal molecules or other appropriate substances. The liquid crystal molecule, for instance, often has a first-axis refractive index (nₒ) and a second-axis refractive index (nₑ). The first-axis refractive index (nₒ) and the second-axis refractive index (nₑ) are normally referred to as the short-axis refractive index and the long-axis refractive index of the liquid crystal molecules. The optically anisotropic medium 180 is arranged according to the distribution of the electric field in the barrier panel 150.

The first electrode layer 162 and the second electrode layer 172 are respectively located at an inner side of the first substrate 160 and at an inner side of the second substrate 170, and the inner sides of the first and second substrate 160 and 170 adjoin the optically anisotropic medium 180. In other words, the optically anisotropic medium 180 is located between the first electrode layer 162 and the second electrode layer 172.

To be specific, in the present embodiment, the first electrode layer 162 includes a plurality of first electrodes 164. The first electrodes 164 are bar-shaped electrodes arranged in parallel, for instance, which should however not be construed as a limitation to the invention. In other embodiments, the first electrodes 164 may also be other appropriate patterned electrodes. An included angle between an extension direction of the first electrodes 164 and the Y-direction is +θ1, and θ1≠0 degree. In addition, the second electrode layer 172 includes a plurality of second electrodes 174. The second electrodes 174 are bar-shaped electrodes arranged in parallel, for instance, which should however not be construed as a limitation to the invention. In other embodiments, the second electrodes 174 may also be other appropriate patterned electrodes. An included angle between an extension direction of the second electrodes 174 and the Y-direction is −θ2, and θ2≠0 degree. In the present embodiment, |θ1−θ2|≦θ, or θ1=θ2. If the included angle is +θ, it means that the included angle is levorotary; if the included angle is −θ, it means that the included angle is dextrorotary. The first electrodes 164 and the second electrodes 174 may be made of a transparent conductive material that includes metal oxide, e.g., indium tin oxide, indium zinc oxide, aluminum tin oxide, aluminum zinc oxide, indium germanium zinc oxide, other appropriate oxide, or a stacked layer containing at least two of the above.

In the present embodiment, the stereo display device 100 further includes an adhesive layer (not shown) for adhering the display panel 110 and the barrier panel 150, for instance. Thereby, after the display panel 110 and the barrier panel 150 are adhered to each other, the barrier panel 150 ensures that the left eye of a user merely observes the pixels in the left-eye image, and that the right eye of the user merely observes the pixels in the right-eye image, so as to achieve the stereo effects. The stereo display device 100 may further include a polarizer (not shown) located on both a surface of the display panel 110 and a surface of the barrier panel 150, for instance.

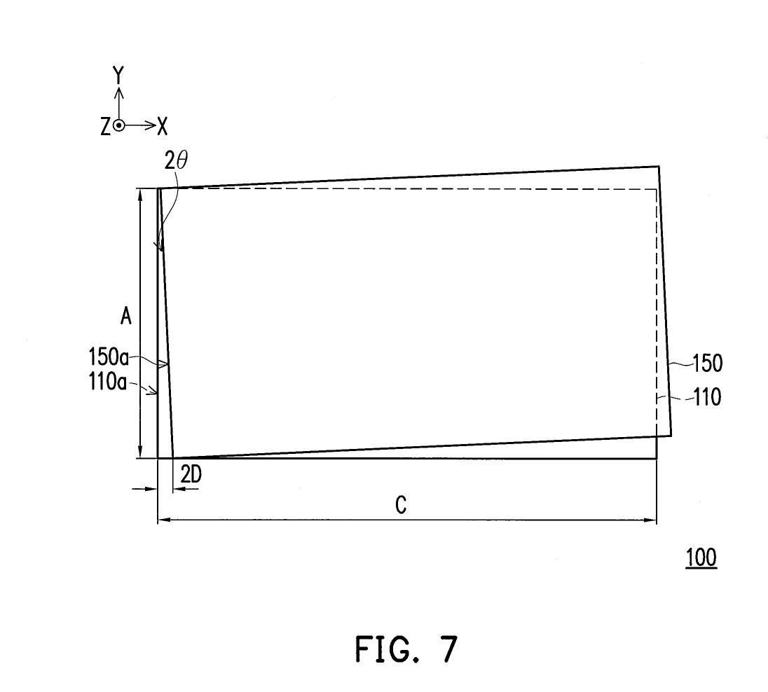

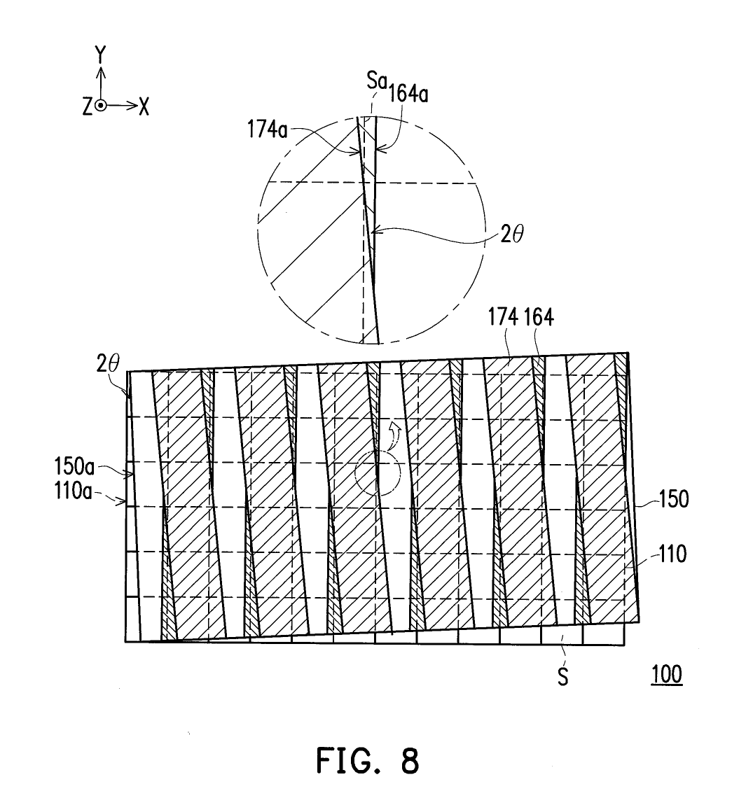

FIG. 7 and FIG. 8 are schematic top views illustrating an assembled stereo display device according to an embodiment of the invention.

To clearly illustrate the relationship between the display panel 110 and the barrier panel 150, FIG. 7 merely shows the edge of the display panel 110 and that of the barrier panel 150, and other components are omitted in FIG. 7. In most cases, when the display panel 110 and the barrier panel 150 are adhered to each other, the unfavorable alignment precision of assembling the machines results in the issue of rotation errors. With reference to FIG. 7, in the present embodiment, a resolution of the display panel 110 is A×C, and A<C. Here, A refers to the number of the sub-pixel units S in each column (i.e., the length of the short side), and C refers to the number of the sub-pixel units S in each row (i.e., the length of the long side). The rotation threshold of alignment error between the display panel 110 and the barrier panel 150 is 2θ (i.e., the included angle between the edge of the display panel 110 and the edge of the barrier panel 150), and 2θ satisfies:

$$2 θ = {tan}^{- 1} ( \frac{2 D}{A \times P} )$$

Here, P represents a width of one pixel unit U, D represents an alignment error threshold between the display panel 110 and the barrier panel 150, and 0.005 degree≦θ≦0.05 degree. For instance, it is assumed that A is 720, C is 1280, and P is 77.1 μm. Under said circumstances, if D is 5 μm, then θ is 0.0052 degree; if D is 50 μm, then θ is 0.052 degree.

In particular, the display panel 110 has a rectangular shape and a first side 110a. The barrier panel 150 has a rectangular shape and a second side 150a. An acute angle 20 between the first side 110a and the second side 150a ranges from 0.01 degree to 0.1 degree. That is, due to the unfavorable alignment precision of assembling the machines, the acute angle is often formed between the first side 110a of the display panel 110 and the second side 150a of the barrier panel 150, the acute angle resulting from the alignment error has the maximum value 2θ, and 0.005 degree≦θ≦0.05 degree. As a matter of fact, the value of 2θ may vary if the alignment precision of assembling the machines varies.

To clearly illustrate the relationship between the sub-pixel units S in the display panel 110 and the electrodes in the barrier panel 150, FIG. 8 merely shows the sub-pixel units S in the display panel 110 and the first and second electrodes 164 and 174 in the barrier panel 150, and other components are omitted in FIG. 8.

With reference to FIG. 8, it should be mentioned that an included angle between an extension direction of the second electrodes 174 and an extension direction of the first electrodes 164 is θ1+θ2=2θ. Hence, when the rotation threshold of alignment error between the display panel 110 and the barrier panel 150 is 2θ, i.e., when the alignment precision of assembling the machines is insufficient, and the insufficient alignment precision leads to the rotation errors (e.g., caused by inaccurate adhesion), the sides 164a of the first electrodes 164 may extend along the Y-direction and are parallel to the sides Sa of the sub-pixel units S, the included angle between the sides 174a of the second electrodes 174 and the sides 164a of the first electrodes 164 is 2θ, and 0.005 degree≦θ≦0.05 degree.

In the present embodiment, after the display panel 110 and the barrier panel 150 are adhered to each other, first electrodes 164 serve as the barrier electrodes and the second electrodes 174 serve as the common electrodes (Corn) if θ1<θ2. Particularly, in the present embodiment, the sides 164a of the first electrodes 164 may extend along the Y-direction and are parallel to the sides Sa of the sub-pixel units S (i.e., the first electrodes are not deviated from the Y-direction), the first electrodes 164 may serve as the barrier electrodes, and the second electrodes 174 may serve as the common electrodes. Due to the alignment errors, the barrier electrodes may be shifted and cannot completely block the underlying sub-pixel units S, thus resulting in the issues of light leakage, color shift, and noise. However, in the present embodiment, the bar-shaped barrier electrodes may be accurately aligned to the sub-pixel units S in each column, the shift of the barrier electrodes caused by the alignment errors may be prevented, and said issues of light leakage, color shift, and noise may be resolved.

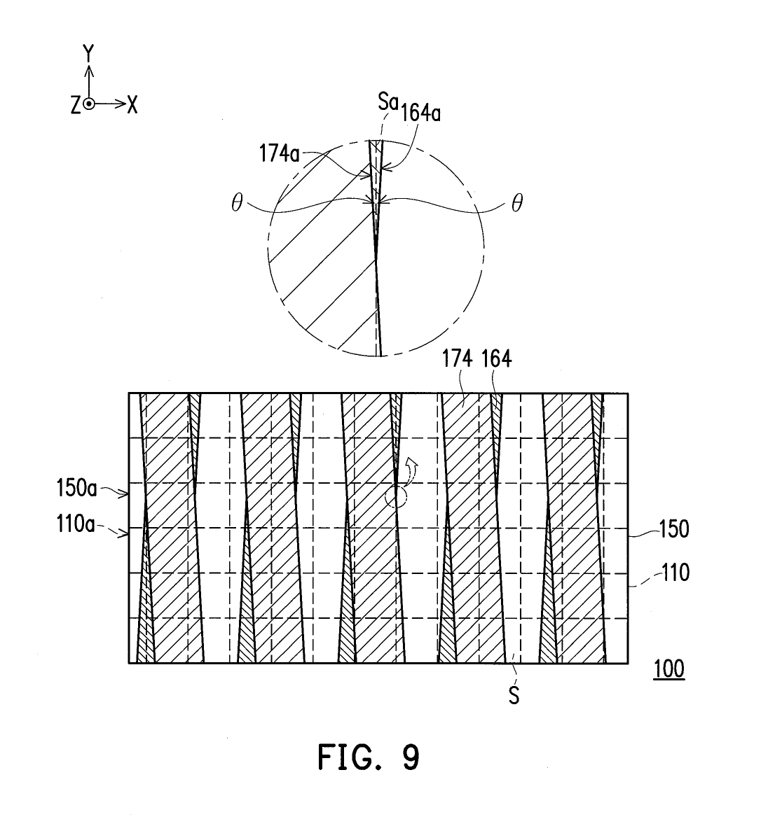

As shown in FIG. 7 and FIG. 8, the display panel 110 and the barrier panel 150 are not accurately aligned and adhered to each other, whereas the invention is not limited thereto. In another embodiment of the invention, as exemplarily shown in FIG. 9, the display panel 110 and the barrier panel 150 are accurately aligned and adhered to each other.

With reference to FIG. 9, when the rotation threshold of alignment error between the display panel 110 and the barrier panel 150 is 0, i.e., when the rotation error resulting from the insufficient alignment precision of assembling the machines has the minimum value (e.g., accurate adhesion), the included angle between the sides 164a of the first electrodes 164 and the sides Sa (or the Y-direction) of the sub-pixel units S is 0, the included angle between the sides 174a of the second electrodes 174 and the sides Sa (or the Y-direction) of the sub-pixel units S is θ, and 0.005 degree≦θ≦0.05 degree.

As provided above, there is an included angle between the extension direction of the first electrodes 164 and the Y-direction, and there is also an included angle between the extension direction of the second electrodes 174 and the Y-direction. Besides, each of said included angles is half the rotation threshold of alignment error (i.e., 20) between the display panel 110 and the barrier panel 150. Hence, the resultant alignment precision is satisfactory no matter whether the display panel 110 and the barrier panel 150 are accurately aligned and adhered to each other. That is, the alignment precision described herein is less than or equal to θ, and 0.005 degree≦θ≦0.05 degree.

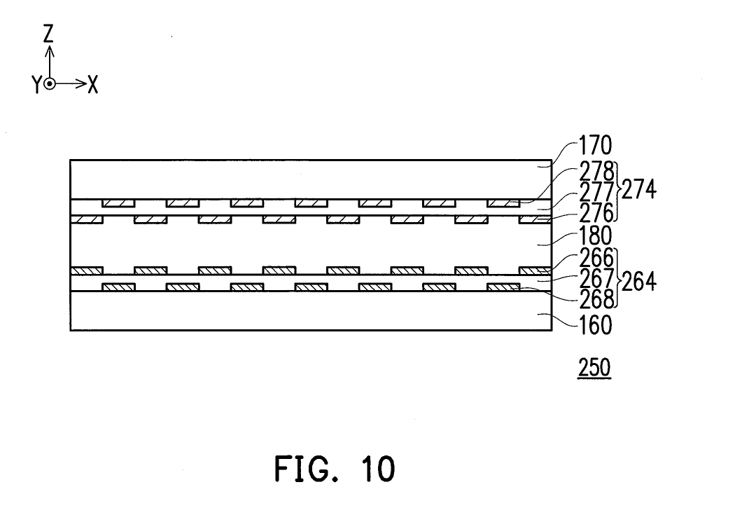

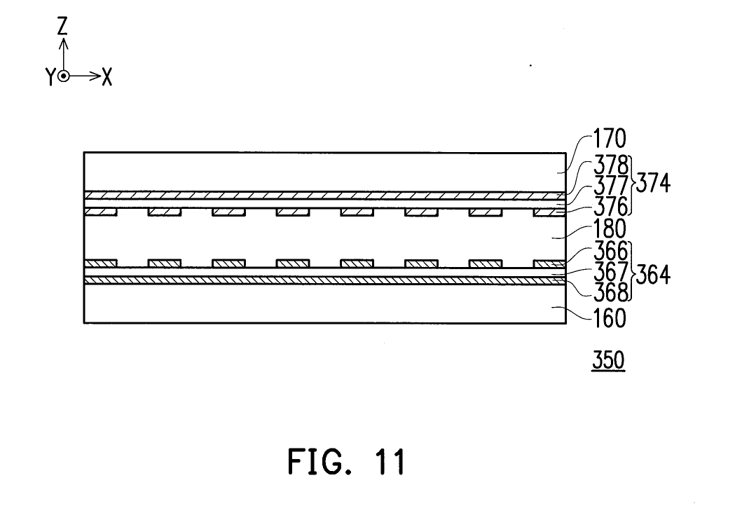

In the previous embodiments shown in FIG. 4 to FIG. 9, the first electrode layer 162 and the second electrode layer 172 respectively have the one-layer electrode structure, whereas the invention is not limited thereto. In other embodiments of the invention, as exemplarily shown in FIG. 10 and FIG. 11, each of the first and second electrode layers may also be a one-layer or multi-layer electrode structure.

FIG. 10 and FIG. 11 are schematic cross-sectional views illustrating a barrier panel according to other embodiments of the invention. The embodiments depicted in FIG. 10 and FIG. 11 are similar to that depicted in FIG. 4; therefore, the identical or similar devices in these embodiments are represented by the identical or similar reference numbers and will not be further explained.

With reference to FIG. 10, in the barrier panel 250, the first electrodes 264 include a plurality of first common electrodes 268, an insulation layer 267, and a plurality of first barrier electrodes 266. The first common electrodes 268 are located on the substrate 160, the insulation layer 267 covers the first common electrodes 268, and the first barrier electrodes 266 are located on the insulation layer 267. In particular, the first barrier electrodes 266 are located above and electrically insulated from the first common electrodes 268. Here, the first common electrodes 268 and the first barrier electrodes 266 are alternately arranged and are patterned electrodes. In addition, the second electrodes 274 include a plurality of second common electrodes 278, an insulation layer 277, and a plurality of second barrier electrodes 276. The second common electrodes 278 are located on the substrate 170, the insulation layer 277 covers the second common electrodes 278, and the second barrier electrodes 276 are located on the insulation layer 277. In particular, the second barrier electrodes 276 are located above and electrically insulated from the second common electrodes 278. Here, the second common electrodes 278 and the second barrier electrodes 276 are alternately arranged and are patterned electrodes.

When the first electrodes 264 serve as the barrier electrodes, and the second electrodes 274 serve as the common electrodes, a barrier potential V1 is applied to the first barrier electrodes 266; at the same time, a common potential (constant potential) Vcom is applied to the first common electrodes 268, the second common electrodes 278, and the second barrier electrodes 276. Here, the barrier potential V1 is higher or lower than the common potential Vcom so as to generate a potential difference. Similarly, when the second electrodes 274 serve as the barrier electrodes, and the first electrodes 264 serve as the common electrodes, a barrier potential V1 is applied to the second barrier electrodes 276; at the same time, a common potential Vcom is applied to the second common electrodes 278, the first common electrodes 268, and the first barrier electrodes 266. Here, the barrier potential V1 is higher or lower than the common potential Vcom so as to generate a potential difference. According to the present embodiment, the first barrier electrodes 266 are located between the first common electrodes 268 and the optically anisotropic medium 180, and the second barrier electrodes 276 are located between the second common electrodes 278 and the optically anisotropic medium 180; however, the invention is not limited thereto. Based on actual demands, the first common electrodes 268 may be located between the first barrier electrodes 266 and the optically anisotropic medium 180, and the second common electrodes 278 may be located between the second barrier electrodes 276 and the optically anisotropic medium 180.

Since the first common electrodes 268 and the first barrier electrodes 266 are alternately arranged, and the second common electrodes 278 and the second barrier electrodes 276 are alternately arranged, the common electrodes and the barrier electrodes belonging to different film layers may be spatially overlapped. Thereby, the common electrodes and the barrier electrodes may be closely arranged, so as to prevent light leakage and color shift and achieve favorable stereo display effects.

In the embodiment depicted in FIG. 10, the number of the common electrodes is plural, which should not be construed as a limitation to the invention. In another embodiment of the invention, as exemplarily shown in FIG. 11, there may be one single common electrode or at least one common electrode.

With reference to FIG. 11, in the barrier panel 350, the first electrodes 364 include a first common electrode 368, an insulation layer 367, and a plurality of first barrier electrodes 366. The first common electrode 368 is located on the substrate 160, the insulation layer 367 covers the first common electrode 368, and the first barrier electrodes 366 are located on the insulation layer 367. In particular, the first barrier electrodes 366 are located above and electrically insulated from the first common electrode 368. Here, the first barrier electrodes 366 are patterned electrodes (e.g., identical to the first barrier electrodes 266 illustrated in FIG. 10), and the first common electrode 368 is a non-patterned electrode which overlaps with the first barrier electrodes 366. In addition, the second electrodes 374 include a plurality of second common electrodes 378, an insulation layer 377, and a plurality of second barrier electrodes 376. The second common electrodes 378 are located on the substrate 170, the insulation layer 377 covers the second common electrodes 378, and the second barrier electrodes 376 are located on the insulation layer 377. In particular, the second barrier electrodes 376 are located above and electrically insulated from the second common electrodes 378. Here, the second barrier electrodes 376 are patterned electrodes (e.g., identical to the second barrier electrodes 276 illustrated in FIG. 10), and the second common electrodes 376 are a non-patterned electrode which overlaps with the second barrier electrodes 376.

To sum up, in the stereo display device provided herein, the included angle between the extension direction of the first electrodes and the Y-direction is +θ1, and the included angle between the extension direction of the second electrodes and the Y-direction is −θ2, and each of the included angles is half the rotation threshold of alignment error (2θ). That is, the electrodes rotating in different directions are respectively arranged on the two substrates of the barrier panel; after the display panel and the barrier panel are adhered to each other, the electrodes deviated from the Y-direction (i.e., the central line) to the less extent may serve as the barrier electrodes, and the electrodes deviated from the Y-direction to the greater extent may serve as the common electrodes. Thereby, the rotation errors may be reduced, and the tolerance of the alignment errors may be doubled, so as to comply with the manufacturing requirements. Moreover, the stereo display device described herein is applicable to products with the large PPI or the SBP. Namely, according to the design of the electrodes in the barrier panel provided herein, the alignment of the extension direction of the barrier electrodes to the central line is precise, and said alignment precision is raised to a level smaller than or equal to half the alignment precision 20 of adhering the machines.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A stereo display device comprising:
a display panel comprising a plurality of sub-pixel units arranged in an array along an X-direction and a Y-direction, wherein at least three sub-pixel units form a pixel unit; and
a barrier panel located at one side of the display panel, the barrier panel comprising:
a plurality of first electrodes, wherein an included angle between an extension direction of the first electrodes and the Y-direction is +θ1, and θ1≠0 degree;
a plurality of second electrodes, wherein an included angle between an extension direction of the second electrodes and the Y-direction is −θ2, and θ2≠0 degree; and
an optically anisotropic medium located between the first electrodes and the second electrodes.

2. The stereo display device as recited in claim 1, wherein a rotation threshold of alignment error between the display panel and the barrier panel is 2θ, and |θ1−θ2|≦θ.

3. The stereo display device as recited in claim 2, wherein a resolution of the display panel is A×C, A<C, and 2θ satisfies:
$$2 θ = {tan}^{- 1} ( \frac{2 D}{A \times P} )$$
wherein P represents a width of one pixel unit, and D represents an alignment error threshold between the display panel and the barrier panel.

4. The stereo display device as recited in claim 2, wherein 0.005 degree≦θ≦0.05 degree.

5. The stereo display device as recited in claim 1, wherein the first electrodes comprise:
at least one first common electrode; and
a plurality of first barrier electrodes located above and electrically insulated from the at least one first common electrode.

6. The stereo display device as recited in claim 5, wherein the second electrodes comprise:
at least one second common electrode; and
a plurality of second barrier electrodes located above and electrically insulated from the at least one second common electrode.

7. The stereo display device as recited in claim 6, wherein the number of the at least one first common electrode and the number of the at least one second common electrode are plural.

8. The stereo display device as recited in claim 1, wherein a color of each column of the sub-pixel units is repeated in a red-green-blue order.

9. The stereo display device as recited in claim 8, wherein a color of each row of the sub-pixel units is identical.

10. The stereo display device as recited in claim 1, wherein a color of each row of the sub-pixel units is repeated in a red-green-blue order.

11. The stereo display device as recited in claim 10, wherein a color of each column of the sub-pixel units is identical.

12. A stereo display device comprising:
a display panel having an edge and comprising a plurality of sub-pixel units arranged in an array along an X-direction and a Y-direction, wherein at least three sub-pixel units form a pixel unit; and
a barrier panel located at one side of the display panel, the barrier panel having an edge, wherein an included angle between the edge of the display panel and the edge of the barrier panel has a rotation threshold of alignment error, and the rotation threshold of alignment error is 2θ,
wherein a resolution of the display panel is A×C, A<C, and 2θ satisfies:
$$2 θ = {tan}^{- 1} ( \frac{2 D}{A \times P} )$$
wherein P represents a width of one pixel unit, and D represents an alignment error threshold between the display panel and the barrier panel.

13. The stereo display device as recited in claim 12, wherein the barrier panel comprises:
a plurality of first electrodes, wherein an included angle between an extension direction of the first electrodes and the Y-direction is +θ1;
a plurality of second electrodes, wherein an included angle between an extension direction of the second electrodes and the Y-direction is −θ2, and θ1=θ2; and
an optically anisotropic medium located between the first electrodes and the second electrodes.

14. The stereo display device as recited in claim 13, wherein the first electrodes comprise:
at least one first common electrode; and
a plurality of first barrier electrodes located above and electrically insulated from the at least one first common electrode.

15. The stereo display device as recited in claim 14, wherein the second electrodes comprise:
at least one second common electrode; and
a plurality of second barrier electrodes located above and electrically insulated from the at least one second common electrode.

16. The stereo display device as recited in claim 15, wherein the number of the at least one first common electrode and the number of the at least one second common electrode are plural.

17. The stereo display device as recited in claim 12, wherein a color of each column of the sub-pixel units is repeated in a red-green-blue order.

18. The stereo display device as recited in claim 17, wherein a color of each row of the sub-pixel units is identical.

19. The stereo display device as recited in claim 12, wherein a color of each row of the sub-pixel units is repeated in a red-green-blue order.

20. The stereo display device as recited in claim 19, wherein a color of each column of the sub-pixel units is identical.

21. A stereo display device comprising:
a display panel having a rectangular shape and a first side, the display panel comprising a plurality of sub-pixel units arranged in an array along an X-direction and a Y-direction; and
a barrier panel located at one side of the display panel, the barrier panel having a rectangular shape and a second side, wherein an acute angle between the first side and the second side ranges from 0.01 degree to 0.1 degree, and the barrier panel comprises a plurality of first electrodes extending along the Y-direction.

22. The stereo display device as recited in claim 21, wherein the barrier panel further comprises a plurality of second electrodes, an included angle between an extension direction of the second electrodes and an extension direction of the first electrodes is 2θ, and 0.005 degree≦θ≦0.05 degree.
